(19) United States
(12) Patent Application Publication
(10) Pub. No.: US 2003/0060955 A1
(43) Pub. Date: Mar. 27, 2003

(54) Method for steering assistance as a function of a driving state

(76) Inventor: Avshalom Suissa, Althengstett (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/224,491

(22) Filed: Aug. 21, 2002

(30) Foreign Application Priority Data
Aug. 23, 2001 (DE) 101 41 425.0

(51) Int. Cl. B62D 5/04

(52) U.S. Cl. 701/41; 701/42; 180/443

(57) ABSTRACT

The invention relates to a method for generating an additive additional torque on the steering wheel of a vehicle as a function of a driving state, and to an apparatus for carrying out the method. It is the object of the invention to find an alternative method and an apparatus for carrying out the method which assists the driver in stabilizing the driving state of the vehicle when unwanted yawing motions occur. According to this, the additional torque is formed by means of a factor κ₁ and the side-slip angle β, the additional torque specifying that steering-wheel position which corresponds to a wheel position of the steered vehicle wheels that serves to stabilize the current driving state. The additional torque is transmitted to the steering wheel by means of an electric motor.

The invention relates to a method for generating an additive additional torque on the steering wheel of a vehicle as a function of a driving state, and to an apparatus for carrying out the method.

A real vehicle has a moment of inertia and, when cornering for example, performs a yawing motion about the vertical axis of the vehicle. As long as this yawing motion corresponds to the driving inputs of the driver or of the driver-assistance system, the driving state is stable as regards the yawing motion of the vehicle, and the driver does not need to intervene. However, dangerous situations arise in the case of unwanted or unexpected yawing motions, initiated, for example, when braking on a slippery road,, in the case of a side wind or in the case of a puncture. As a result, a disturbing yawing moment about the vehicle's vertical axis is generated, leading to a yawing motion of the vehicle which is surprising for the driver. Owing to his reaction time and the overreaction which may follow, the driver often does not cope with such situations safely and quickly enough to avoid an uncontrolled motion of the vehicle or to re-stabilize it, and this can lead to an accident.

Automatic driver assistance systems can react more quickly and more accurately than humans and can thus prevent accidents. These are feedback control systems which measure the yawing motion, e.g. by means of a yaw-rate sensor, and compensate for the causative disturbing moment by means of a countermoment. This countermoment can be produced by individual-wheel braking or additional steering of the rear wheels or the front wheels, for example.

DE 196 50 691 C2 has disclosed a method for assisting a driver of a road vehicle to steer by means of additional steering of the front wheels. In the method, the total wheel lock angle is determined by addition from the wheel lock angle commanded by the driver and a kinematically calculated additional steering angle.

It is, then, the object of the present invention to find an alternative method and an apparatus for carrying out the method which assists the driver in stabilizing the driving state of the vehicle when unwanted yawing motions occur.

According to the invention, this object is achieved by the features of claims 1 and 7.

The additional torque applied to the steering wheel is accordingly formed by means of a factor κ₁, and the side-slip angle β. It is determined in such a way that the steering-wheel position specified by the additional torque corresponds to a wheel position that serves to stabilize the current driving state. In this arrangement, the wheel position is advantageously such that the steered vehicle wheels are aligned essentially in the direction of the current direction of motion of the centre of gravity of the vehicle. If the steering wheel is moved into the steering-wheel position specified by the additional torque, the driving state of the vehicle is stabilized or the tendency of the vehicle to assume an unstable driving state is reduced owing to the corresponding wheel position of the steered vehicle wheels.

At the beginning of a vehicle skidding process, the side-slip angle is large. The additional torque then specifies a steering-wheel angle corresponding to a wheel position that brings about a reduction in the current side-slip angle. The additional torque gives the driver haptic feedback to indicate in which direction the steering wheel and hence the steered wheels of the vehicle should be steered in order to re-establish or increase driving stability.

The haptic feedback by means of the additional torque on the steering wheel of the vehicle is expediently configured in such a way that the driver can still hold the steering wheel firm against the additional torque. For this purpose, the absolute value of the additional torque can be limited to a maximum, for example. Since the driver retains overall control of the vehicle via the haptic feedback, the method represents an ideal means of assisting the driver, leaving him control over the vehicle. The task of steering is not removed from him completely; instead the driver is assisted in the task of steering.

By way of the factor κ₁, the additional torque can be directly proportional to the side-slip angle β.

Simply calculating the additional torque by means of the factor κ₁, demands little in the way of computing capacity. In principle, the factor κ₁ can be specified arbitrarily and can also depend on other driving-state values of the vehicle, e.g. on the vehicle velocity. The value of the factor or, in the velocity-dependent case, the relationship between the vehicle velocity and the factor, can be determined in advance by means of model calculations.

The method can be employed on steering systems with a mechanical or hydraulic connection between the steering wheel and the steered vehicle wheels and also on “steer-by-wire” systems, in which there is no permanent mechanical or hydraulic connection between the steering wheel and the steered vehicle wheels.

In a development of the method according to the invention, the yaw velocity and/or the yaw acceleration are also taken into account in forming the additive additional torque. Thanks to these additional components in the determination of the additive additional torque, the method is also suitable for improving the handling properties of the vehicle in the “normal driving range”, i.e. in a driving state which is stable as regards the yawing motion, the values for the side-slip angle β being smaller in comparison with unstable yawing motions (e.g. skidding).

There are various ways of configuring and developing the teaching of the present invention in an advantageous manner. For this purpose, attention is drawn, on the one hand, to the subclaims and, on the other hand, to the following explanation of an embodiment. The drawing illustrates an embodiment of the method according to the invention and a corresponding apparatus. In the drawing, in which each of the figures is a schematic illustration,

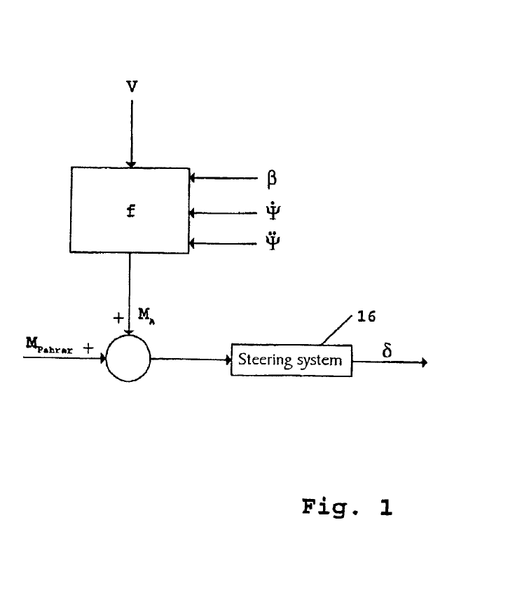

FIG. 1 shows the processing unit and the superimposition of the additional torque on the torque applied to the steering wheel by the driver,

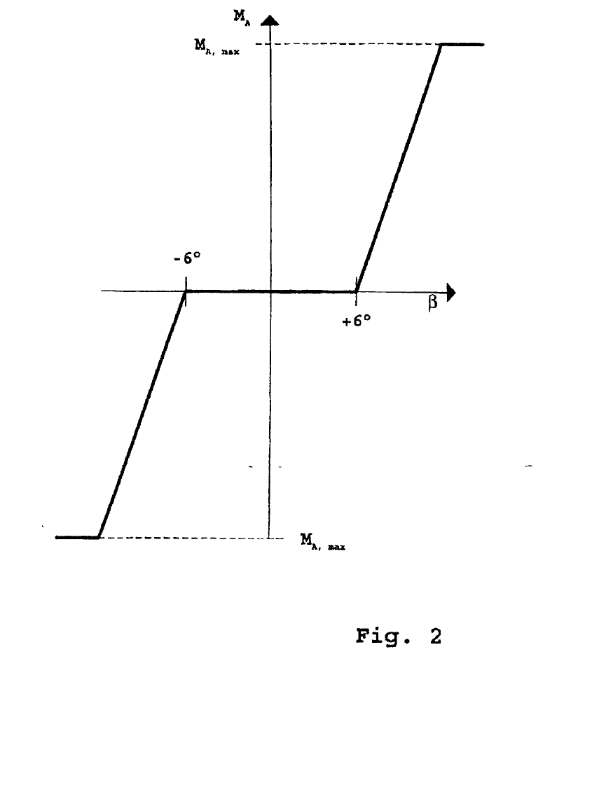

FIG. 2 shows the additive additional torque M_{A} as a function of the side-slip angle β during the performance of the method according to the invention,

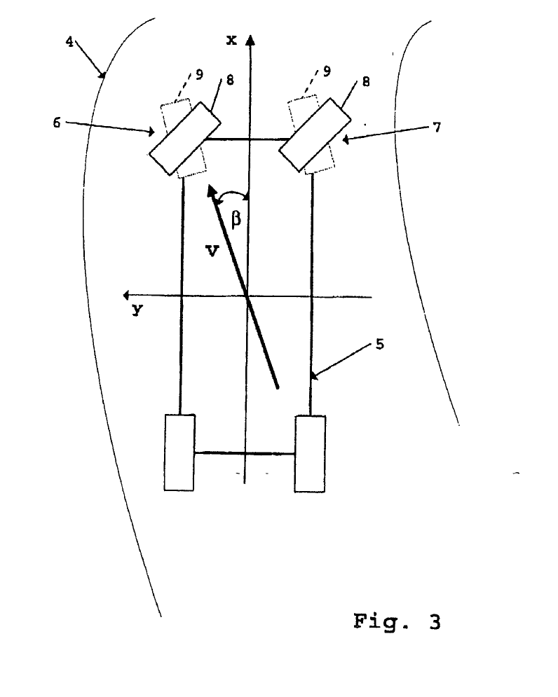

FIG. 3 shows a vehicle in plan view, both the current wheel position of the steered wheels and the wheel position that corresponds to the steering-wheel position specified to the driver by the method according to the invention being shown, and

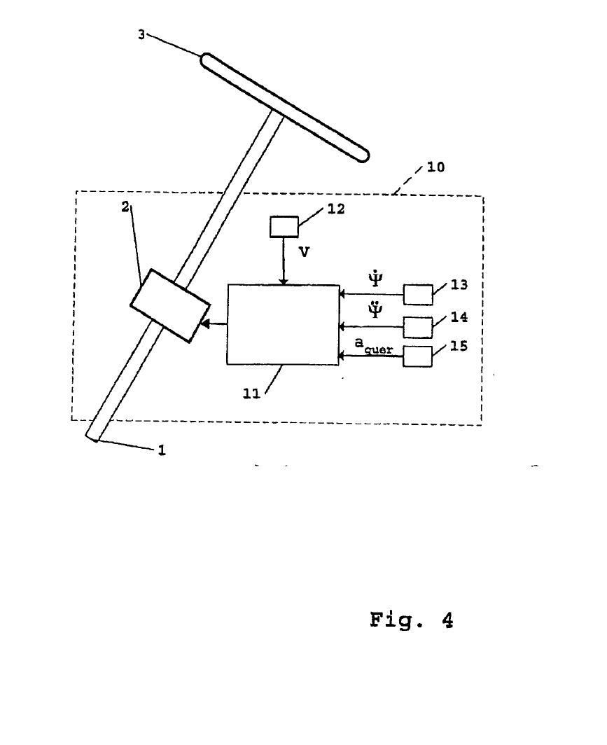

FIG. 4 shows an apparatus for carrying out the method according to the invention.

The aim of the method according to the invention for generating an additive additional torque on the steering wheel 3 of a vehicle 5, e.g. a passenger car or a truck, as a function of the driving state is to assist the driver in the task of driving, especially when the vehicle 5 is in the transition range from a stable to an unstable driving state as regards the yawing motion of the vehicle 5.

An unwanted yawing motion of the vehicle 5 is indicated by a side-slip angle β that exceeds a certain limiting value, e.g. about 6°. To stabilize the vehicle, a steering intervention is then necessary. To assist the driver, an additional torque M_{A} is, according to the invention, applied to the steering wheel by an apparatus 10 in order to give the driver haptic feedback as to what motion of the steering wheel is necessary to stabilize the vehicle 5 in the present driving situation. The apparatus 10 does not perform an automatic steering intervention but merely specifies the steering-wheel angle and thus the corresponding wheel position of the steered vehicle wheels 6, 7 that has a stabilizing effect on the yawing motion of the vehicle. If the driver follows the specification, the side-slip angle β is reduced and the yawing motion of the vehicle 5 re-stabilizes. For this purpose, the driver could simply release the steering wheel, allowing the additional torque M_{A} to bring the steering wheel automatically into the steering-wheel position required to stabilize the yawing motion.

FIG. 3 shows the vehicle schematically in plan view with the longitudinal vehicle axis x and the transverse vehicle axis y. The vehicle 5 is supposed to follow a road 4 along a right-hand bend. The steered vehicle wheels 6, 7 are therefore in the first wheel position 8, illustrated by a solid line, and are pointing in the direction of the road. The actual direction of motion of the vehicle 5 is indicated by the velocity vector “v”. The vehicle 5 is instantaneously moving towards the outside of the bend. The vehicle 5 cannot perform the yawing motion defined by the first wheel position 8, owing to inadequate side forces on the vehicle wheels on a slippery road 4, for example. This deviation between the intended yawing motion and the actual yawing motion results in a large side-slip angle β of, for example, 10°. (Only a qualitative indication, not a quantitative indication, is given in FIG. 3). To counteract this unstable yawing behaviour, an additional torque M_{A} is applied to the steering wheel 3, specifying to the driver the steering-wheel position which he should adopt to stabilize the driving state. This specification of the steering-wheel position corresponds to the second wheel position 9 of the steered wheels 6, 7 shown in broken lines in FIG. 3, the wheels being aligned approximately parallel to the current direction of motion of the centre of gravity of the vehicle.

FIG. 1 shows a schematic representation of the interaction between the additional torque M_{A} and the manual torque M_{Fahrer} applied by the driver. The sum of the additional torque M_{A} and the manual torque M^{Fahrer} is transmitted to the steering system 16, which sets the steering angle δ at the steered wheels 6, 7.

Once the yawing motion of the vehicle 5 has been stabilized, the driver can steer the vehicle 5 along the desired track again.

In the preferred exemplary embodiment, the additional torque M_{A} is determined in accordance with the function f in a processing unit 11 of the apparatus 10:

f:M_{A}=κ₁(v)·β+κ₂(v)\dot{ψ}+κ₃(v)\ddot{ψ}

where

κ₁ (v), κ₂ (v), κ₃ (v) are freely selectable velocity-dependent factors,

β is the side-slip angle,

\dot{ψ} is the yaw rate and

\ddot{ψ} is the yaw acceleration.

The input variables, namely the yaw rate \dot{ψ}, the yaw acceleration \ddot{ψ} and the velocity v of the vehicle can be measured by appropriate means 12, 13, 14. The current side-slip angular velocity \dot{β} can be determined kinematically by means of the yaw rate \dot{ψ}, the lateral acceleration a_{quer}—which can likewise be measured by appropriate means 15—and the vehicle velocity v. The side-slip angle β is then determined by integration of the side-slip angular velocity \dot{β}. In the preferred exemplary embodiment of the apparatus 10, the side-slip angle β is determined in the processing unit 11. In this arrangement, the input variables, namely the yaw rate \dot{ψ}, the yaw acceleration \ddot{ψ}, the vehicle velocity v and the lateral acceleration a_{quer}, are fed to the processing unit 11 by the means 12, 13, 14, 15 (FIG. 4).

The factors κ₁, κ₂, κ₃ are determined by means of model calculations and are chosen as a function of velocity in the preferred embodiment. Fundamentally, they can be chosen arbitrarily and stored in the processing unit 11. As a first approximation, however, velocity-dependent consideration is not necessary.

Owing to the fact that the yaw rate \dot{ψ} and the yaw acceleration \ddot{ψ} are taken into account in determining the additional torque M_{A}, not only is steering assistance given to the driver in the range of yawing motions that are critical to the driving state but additional assistance to the driver is also achieved in the normal driving range that is not critical for the driving state. This makes the vehicle 5 easier to handle for the driver.

The factors κ₂ and κ₃ can be set constantly to zero if driver assistance by means of the method according to the invention and the apparatus 10 according to the invention is intended only to improve behaviour in the transition range from the stable to the unstable driving state of the vehicle 5.

In defining the factors κ₁, κ₂, κ₃, account should be taken of the fact that the additive additional torque M_{A} is intended as haptic feedback to the driver via the steering wheel 3. The factors κ₁, κ₂, κ₃ are therefore defined in such a way that the additional torque M_{A} is limited and the driver does not lose overall control over the motion of the steering wheel.

As an alternative, the additional torque M_{A} can be limited in terms of its absolute value to a maximum of M_{A,max}, independently of the factors κ₁, κ₂, κ₃, as indicated in FIG. 2. This too ensures that the additional torque M_{A} applied to the steering wheel 3 does not assume values which would tear the steering wheel 3 out of the hands of the driver.

FIG. 2 shows the additive additional torque M_{A} as a function of the side-slip angle β. Here, the factors κ₂, κ₃ have been set constantly to zero. The range for small side-slip angles, i.e. −6°<β<+6°, corresponds to the normal driving range, no additional torque M_{A} being applied to the steering wheel 3. If the absolute value of the side-slip angle β is about 6°, it is inferred that the vehicle 5 is in the transition range from stable yawing behaviour to unstable yawing behaviour. As the side-slip angle becomes larger—according to the example β<−6° and β>+6°—an additional torque M_{A} acts on the steering wheel 3 to give haptic feedback to the driver, specifying for him the steering-wheel position, and hence also the corresponding wheel position of the steered vehicle wheels 6, 7, at which the yawing motion of the vehicle 5 will re-stabilize.

The additive additional torque M_{A} determined in the processing unit 11 is transmitted to the steering wheel 3 of the vehicle 5 by means of a motor, e.g. an electric motor 2. For this purpose, the electric motor 2 acts on the steering column 1. In principle, the electric motor 2 can act on any part connected in a rotationally fixed manner to the steering wheel 3 in the direction of rotation of the steering wheel 3 in order to transmit an additional torque M_{A} to the steering wheel 3.

In the exemplary embodiment, the electric motor 2 is designed as a hollow-shaft motor. As an alternative to the electric motor 2, other motors, such as fluid-operated motors, can be used.

Patent claims

1. Method for generating an additive additional torque on the steering wheel (3) of a vehicle (5) as a function of a driving state, the additional torque being formed by means of a factor κ₁ and the side-slip angle β, and the additional torque specifying that steering-wheel position which corresponds to a wheel position of the steered vehicle wheels (6, 7) that serves to stabilize the current driving state.

2. Method according to claim 1, characterized in that the steering-wheel position specified by the additional torque corresponds to a wheel position in which the steered vehicle wheels are aligned essentially in the direction of the current direction of motion of the centre of gravity of the vehicle.

3. Method according to claim 1 or 2, characterized in that the additional torque is additionally formed by means of a factor κ₂ and the yaw velocity.

4. Method according to one of claims 1 to 3, characterized in that the additional torque is additionally formed by means of a factor κ₃ and the yaw acceleration.

5. Method according to claims 1 to 4, characterized in that the factor κ₁ and/or the factor κ₂ and/or factor κ₃ are formed as a function of velocity.

6. Method according to claims 1 to 5, characterized in that the absolute value of the additional torque is limited to a value such that the driver can still hold the steering wheel firm against the additional torque.

7. Apparatus (10) for carrying out the method according to one of the preceding claims, there being means for determining the side-slip angle, the side-slip angle being fed, for the purpose of determining the additional torque, to a processing unit (11), which activates an electric motor that transmits the additional torque to the steering wheel.

8. Apparatus according to claim 7, characterized in that, in addition
there are means (13) for measuring the yaw velocity and/or
there are means (14) for measuring the yaw acceleration and/or
there are means for measuring the vehicle velocity (12),
the yaw velocity and/or the yaw acceleration and/or the vehicle velocity are fed to the processing unit, for the purpose of determining the additional torque.
